(19) United States
(12) Patent Application Publication
(10) Pub. No.: US 2008/0025620 A1
(43) Pub. Date: Jan. 31, 2008

(54) Data compression apparatus and data compressing program storage medium

(75) Inventor: Yukio Sugita, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, MINATO-KU (JP)

(21) Appl. No.: 11/878,819

(22) Filed: Jul. 27, 2007

(30) Foreign Application Priority Data
Jul. 28, 2006 (JP) 2006-206621

(51) Int. Cl. G06K 9/36

(52) U.S. Cl. 382/232

(57) ABSTRACT

A data compression apparatus and a data compressing program storage medium attain a high compression rate and a high-speed compression speed in a binary image data compressing process. A data compression apparatus which performs a data compressing process on data to be compressed and formed by a sequence of values each expressed by a 1-bit value includes: a data conversion section which generates new data to be compressed, formed by a sequence of values each expressed by a 1-bit value that indicates whether or not an adjacent value is an equal value in the sequence of values; and a data compression section which performs a compressing process on the new data generated by the data conversion section.

### BACKGROUND OF THE INVENTION

1. Field of the Invention

The present invention relates to a data compression apparatus which compresses data such as image data and a medium storing a data compressing program that causes an information processing apparatus such as a computer to operate as the data compression apparatus.

2. Description of the Related Art

With the recent development of information communication techniques, there is an increasing request to process and communicate character information and image information as image data. If a large amount of image data is to be communicated, it takes a long time to communicate image data. Therefore, it is necessary to perform a compressing process on the image data to shorten the time required to communicate the image data.

Image data includes image data configured by a sequence of two types of values of “1” and “0” (what is called binary image data). The binary image data has been conventionally and widely used in facsimile communications, and it has been requested to perform the compressing process to shorten the time required in the communications. The typical well-known compressing method for the binary image data is to estimate the pixel value of an object pixel from the pixel value of a surrounding pixel, convert the estimation result data into blocks and read the data as continuous 16-bit values, and finally perform a Huffman coding process. Furthermore, there is a method proposed for compressing binary image data as a further improved compressing method to further improve the compression rate by performing the Huffman coding process on the data of the object block with a Huffman table switched depending on the characteristic of data of the surrounding blocks (for example, refer to the Japanese Patent Laid-Open No. 2000-333020).

Recently, binary image data has been used not only for transfer data of a facsimile, but also for drawn data of a circuit board pattern in the exposure equipment that forms a pattern on the circuit board by receiving data from a server. As the drawn data of a circuit board pattern, the data is to be transferred at a higher speed than the data in facsimile. Therefore, it is necessary to compress binary image data at a high compression rate and a high speed. In the compression system described in the Japanese Patent Laid-Open No. 2000-333020, it is hard to attain a sufficient compression rate and compression speed for the requested compression, and a further technique is required to perform a binary image data compressing process.

### SUMMARY OF THE INVENTION

The present invention has been made in view of the above circumstances and provides a data compression apparatus and a data compressing program storage medium appropriate for attaining the high compression rate and the high-speed compression for performing a binary image data compressing process.

The data compression apparatus according to the present invention performs a data compressing process on the data to be compressed, the data being formed by a sequence of values each expressed by a 1-bit value, the apparatus includes:

a data conversion section which generates new data to be compressed, the new data being formed by a sequence of values each expressed by a 1-bit value, the 1-bit value indicating whether or not an adjacent value is an equal value in the sequence of values; and

a data compression section which performs a compressing process on the new data generated by the data conversion section.

In the description above, the word “adjacent” in the “values each expressed by a 1-bit value, the 1-bit value indicating whether or not an adjacent value is an equal value” can refer to “being adjacent on a data stream,” but is not limited to the meaning. For example, if the two-dimensional image data is processed as one-dimensional stream data, then the data can be adjacent when it is viewed as two-dimensional images.

Further, the data compression section may perform a compressing process on the data generated by the data conversion section using, as a unit of the compressing process, an 8-bit value formed by a continuous sequence of 8 values each expressed by 1-bit value.

In addition, it is desired that, in the data compression apparatus according to the present invention, the data compression section performs a reversible compressing process on the data generated by the data conversion section.

Additionally, it is preferable that, in the data compression apparatus according to the present invention, the data compression section includes: a first coding section which outputs values in the new data excluding one or more predetermined compression object values as they are and outputs a coded value representing the compression object value and a coded value representing a number of repetitions of the compression object value; and a second coding section which performs an entropy coding process on the data coded by the first coding section using a table for correspondence between a code and a value. In this case, it is further preferable that the second coding section performs a Huffman coding process on the data coded by the first coding section using a Huffman table.

Furthermore, it is desired that, in the data compression apparatus according to the present invention, the data compression section includes: a first coding section which outputs values in the new data excluding one or more predetermined compression object values as they are and outputs a coded value representing the compression object value and a coded value representing a number of repetitions of the compression object value; a histogram calculation section which obtains a histogram of a value occurring in the data coded by the first coding section; a code assignment section which assigns a code having a shorter length for a value of a higher frequency of occurrences to a table for correspondence between a code and a value on a basis of the histogram obtained by the histogram calculation section; and a second coding section which performs an entropy coding process on the data coded by the first coding section using a table with a code assigned by the code assignment section.

A data compressing program storage medium according to the present invention storing a data compressing program that is incorporated into and causes an information processing apparatus to perform a data compressing process on the data to be compressed, the data being formed by a sequence of values each expressed by a 1-bit value. The data compressing program implements in the information processing apparatus: a data conversion section which generates new data to be compressed, the new data being formed by a sequence of values each expressed by a 1-bit value, the 1-bit value indicating whether or not an adjacent value is an equal value in the sequence of values; and a data compression section which performs a compressing process on the new data generated by the data conversion section.

Only the basic mode of the data compressing program storage medium according to the present invention is described in this specification to avoid duplicate descriptions. However, the data compressing program according to the present invention includes not only the basic mode, but also various modes corresponding to the respective modes of the above-mentioned data compression apparatuses.

A component such as a data compressing section which the data compressing program according to the present invention implements in a computer can be configured with one program part for one component, with plural program parts for one component, and with plural components by one program part. These components can be configured such that the operations can be performed by the components themselves, or by issuing an instruction to a program or a program part incorporated into a computer.

According to the data compression apparatus and the data compressing program storage medium of the present invention, the data compression section performs a compressing process on the new data generated by the data conversion section.

The data to be compressed that is formed by a sequence of values each expressed by 1-bit value generally tends to be continuous occurrences of the same values. Therefore, the data of a sequence values indicating that the adjacent values are the same values can be generated by converting the data to be converted into new data to be compressed that is formed by a sequence of values each expressed by 1-bit value indicating whether or not the adjacent value in the data is the same value. This conversion makes the data to be compressed into an easily compressed state.

Thus, since the data to be compressed can be converted into an easily compressed state, a sufficient compression rate can be attained although the data compression section performs a reversible compressing process. Especially for the data including image information, the reversible compressing process can avoid the degradation of image quality.

Additionally, if the data compression section is provided with the first coding section, only the compression object values in the data converted into an easily compressed state is subjected to coding generating a coded value representing the compression object value and a coded value representing the number of repetitions of the compression object value, thereby avoiding the problem that the resultant data is more redundant than the original data and improving the compression rate.

Additionally, when the data compression section is provided with the second coding section, it is expected that the compression rate can be further improved by the entropy coding process (typically by the Huffman coding process).

Furthermore, if the data compression section is provided with a histogram calculation section and a code assignment section, and if the second coding section performs the entropy coding process (for example, the Huffman coding process) using a table with a code assigned by the code assignment section, the compression rate can be improved much more than the entropy coding process performed using the table for which the assignment of a code is fixed.

### BRIEF DESCRIPTION OF THE DRAWINGS

FIG. 1 shows an example of a circuit board pattern exposure system to which the data compressing technique is applied;

FIG. 2 shows a flow of a data processing in the circuit board pattern exposure system;

FIG. 3 is a block diagram of an image compression apparatus that is an embodiment of the data compression apparatus according to the present invention;

FIG. 4 shows the configuration of a hardware of a host controller shown in FIG. 1;

FIG. 5 schematically shows the configuration of an image compressing process program storage medium that is an embodiment of the data compressing program storage medium according to the present invention;

FIG. 6 shows the structure of image data in a binary image file input to the data compression apparatus shown in FIG. 3;

FIG. 7 shows the structure of data after an arithmetic process of an exclusive logical sum is performed on the image data in the binary image file input to the data compression apparatus shown in FIG. 3;

FIG. 8 is an explanatory view of a coding process by a run length coding section shown in FIG. 3;

FIG. 9 shows an algorithm of a coding process to be performed on a compression object value by the run length coding section;

FIG. 10 shows an example of the coding process depending on the number of repetitions by the run length coding section shown in FIG. 3;

FIG. 11 shows an example of a result of a scanning process by a data scanning section;

FIG. 12 shows an example of a Huffman table; and

FIG. 13 shows a practical example of a code string prepared for the Huffman table.

### DETAILED DESCRIPTION OF THE INVENTION

Embodiment(s) of the present invention is described below by referring to the attached drawings.

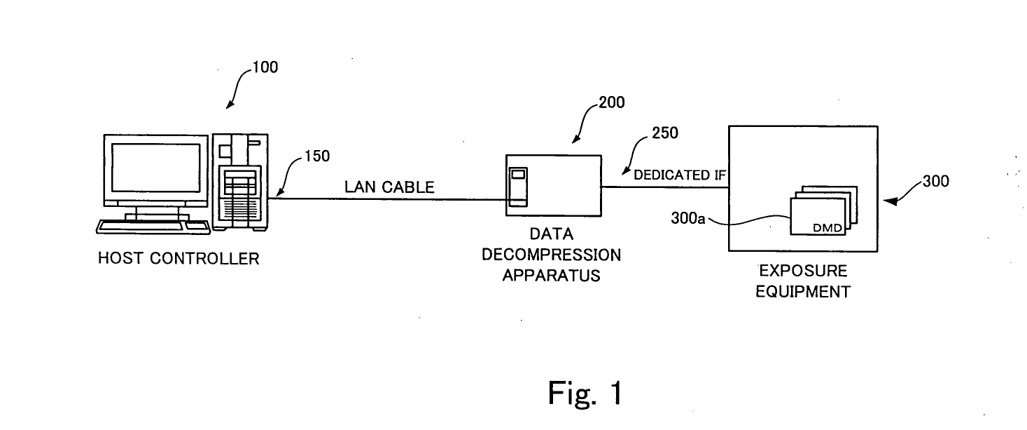

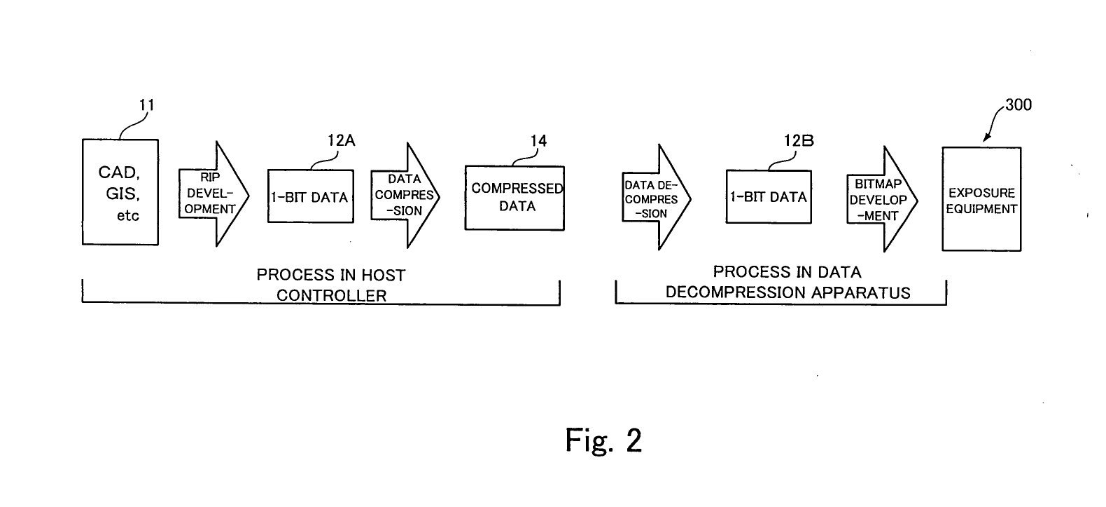

FIG. 1 shows an example of a circuit board pattern exposure system to which the data compressing technique according to the present invention is applied. FIG. 2 shows the flow of the data processing in the circuit board pattern exposure system shown in FIG. 1.

The circuit board pattern exposure system includes a host controller 100, a data decompression apparatus 200, and exposure equipment 300 as shown in FIG. 1. The host controller 100 is connected to the data decompression apparatus 200 via a LAN cable 150, and the data decompression apparatus 200 is connected to the exposure equipment 300 via a dedicated interface cable 250.

In the host controller 100, as shown in FIG. 2, RIP (raster image processing) is performed on drawn data 11 representing an object to be drawn (circuit board pattern) such as CAD data, GIS data, etc. as a line drawing, and 1-bit data 12A formed by a sequence of “1” or “0” is generated. Furthermore, compressed data 14 is generated by performing a data compressing process on the 1-bit data 12A, and transferred to the data decompression apparatus 200 from the host controller 100 through the LAN cable 150 shown in FIG. 1. The data decompression apparatus 200 performs a data decompressing process on the compressed data 14 transferred from the host controller 100. The resultant data is reconstructed to 1-bit data 12B in the state before the host controller 100 performs the data compressing process, developed on a bit map, and transmitted to the exposure equipment 300. The exposure equipment 300 is provided with a DMD (digital micro-mirror device) for digitally controlling light using a micro-mirror in units of micron. The DMD is well known for its high response capability. The exposure equipment 300 forms a circuit board pattern expressed with the input data by the exposing process using the DMD.

In this circuit board pattern exposure system, the host controller 100 performs a data compressing process on data, and then transfers the compressed data to the data decompression apparatus 200, thereby shortening the data transfer time from the host controller 100 to the data decompression apparatus 200, and successfully improving the operation efficiency in forming a circuit board pattern.

The embodiment of the present invention described below refers to an image compression apparatus incorporated into a host controller in the entire system shown in FIG. 1, and more practically to a process of performing a data compressing process on the 1-bit data 12A in the host controller shown in FIG. 2.

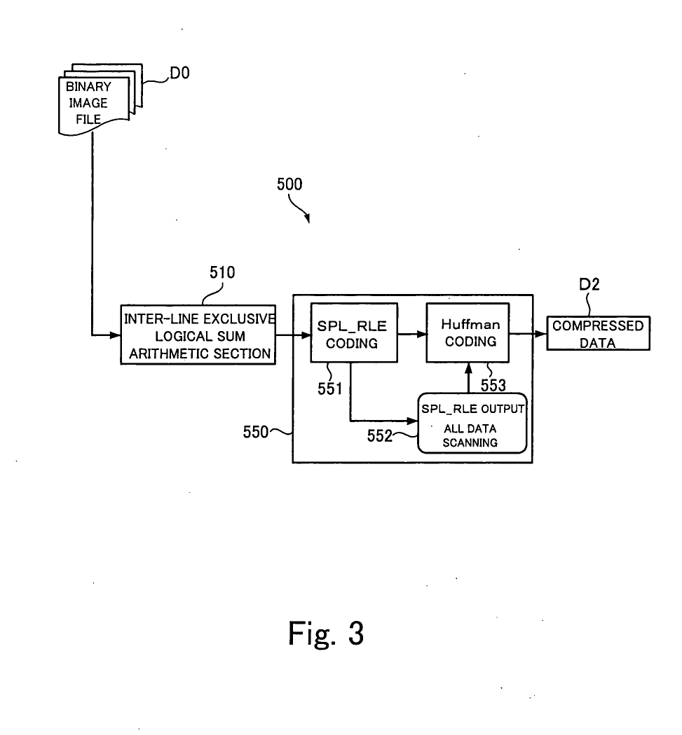

FIG. 3 is a block diagram of the image compression apparatus that is an embodiment of the data compression apparatus according to the present invention.

An image compression apparatus 500 shown in FIG. 3 performs a reversible compressing process on 1-bit data formed by a sequence of “1” or “0”. To perform the reversible compressing process, the apparatus includes an inter-line exclusive logical sum arithmetic section 510 and a compression section 550. The inter-line exclusive logical sum arithmetic section 510 and the image compression apparatus 500 are described later in detail, but the flow of the image data in the image compression apparatus 500 is shown below.

The binary image file D0 (in the present embodiment, the file storing 1-bit data as shown in FIG. 2) is first input to the inter-line exclusive logical sum arithmetic section 510. The 1-bit data is configured by arranging in a secondary scanning direction orthogonal to a primary scanning direction a predetermined number of lines as a sequence of “1” or “0” in a predetermined primary scanning direction. The inter-line exclusive logical sum arithmetic section 510 performs an arithmetic operation for an exclusive logical sum on adjacent lines. An arithmetic operation for an exclusive logical sum refers to an arithmetic operation performed such that, when there are equal values at the same positions in the primary scanning direction in two lines to be processed (that is, when both values are “0” or “1”), “0” is output, and when the values at the same positions in the primary scanning direction are different values (that is, one is “0” and the other is “1”), “1” is output. The inter-line exclusive logical sum arithmetic section 510 corresponds to an example of the data conversion section in the present invention.

The data obtained after the arithmetic operation for an exclusive logical sum generated by the inter-line exclusive logical sum arithmetic section 510 is input to the compression section 550 and performs the compressing process. The compression section 550 corresponds to an example of the data compression section according to the present invention. The compression section 550 is provided with a run length coding section 551, a data scanning section 552, and a Huffman coding section 553, and the data after the arithmetic operation for the exclusive logical sum is first input to the run length coding section 551. It is assumed, in the run length coding section 551, that an 8-bit value is expressed by eight 1-bit values in each block after dividing 1-bit values in each line into eight blocks. In the data, the presence of a predetermined 8-bit value as a compression object value, and a number of repetitions of the 8-bit values in the data are detected. Next, on the basis of the detection result, the run length coding section 551 performs a coding process by outputting data recognized as a sequence of 8-bit values as it is excluding the compression object value, and outputting the compression object value as the compression object value itself and a code of a value representing the number of repetitions of the compression object values. The run length coding section 551 corresponds to an example of the first coding section according to the present invention. The data processed in the coding process by the run length coding section 551 is input to both data scanning section 552 and Huffman coding section 553. The data scanning section 552 scans all data coded by the run length coding section 551, and the frequency of occurrences (histogram) of all 8-bit values in the data is obtained. Furthermore, the data scanning section 552 assigns a code having a shorter code length to a value having a higher frequency of occurrence on the Huffman table on the basis of the obtained data histogram (frequency of occurrence of a value). The data scanning section 552 corresponds to an example of the histogram calculation section and the code assignment section according to the present invention.

The Huffman table whose value has a code assigned by the data scanning section 552 is passed to the Huffman coding section 553. The Huffman coding section 553 performs a coding process of replacing the 8-bit value forming the data input to the Huffman coding section 553 according to the passed Huffman table with a code on the basis of the Huffman table, that is, a code represented by a shorter bit length for a value having a higher frequency of occurrence. The Huffman coding section 553 corresponds to an example of the second coding section according to the present invention.

The data on which the Huffman coding process is performed by the Huffman coding section 553 is provided with the compression information including the assignment table or values and codes assigned by the data scanning section 552, and output as compressed data D2 from the compression section 550.

Thus, the compressed data D2 output from the compression section 550 is transferred to the data decompression apparatus 200 through the LAN cable 150 shown in FIG. 1. The data decompression apparatus 200 performs the data decompressing process on the received compressed data D2. However, in the data decompressing process, the decoding process corresponding to various coding processes shown in FIG. 3 is performed, and the same binary image data as in the original binary image file is reconstructed.

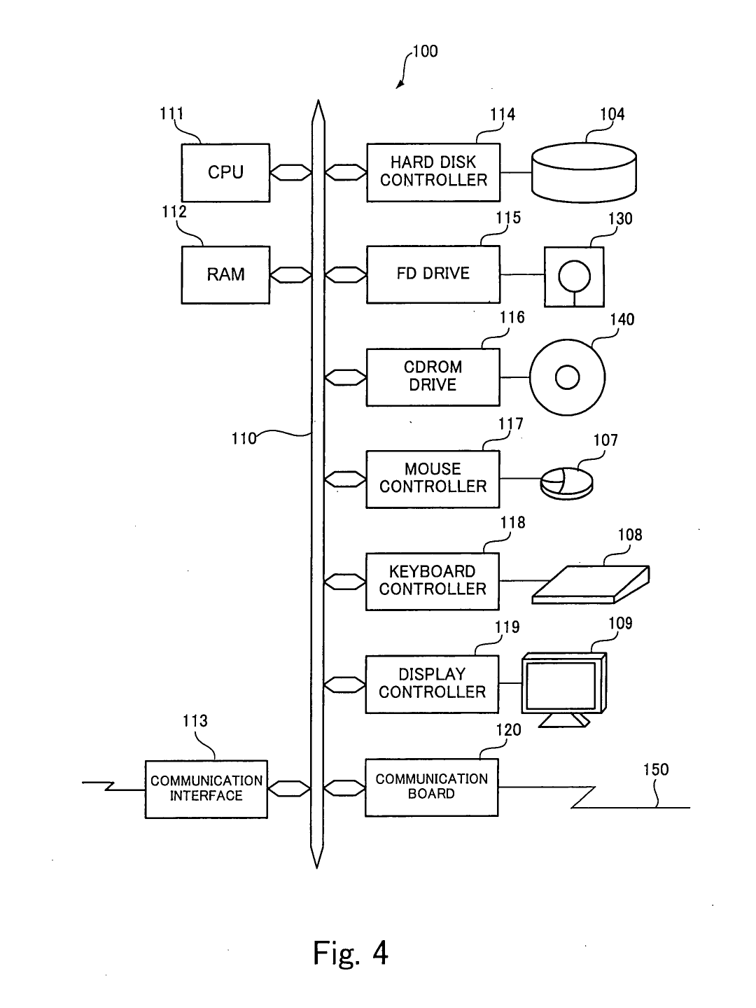

FIG. 4 shows the configuration of the hardware of the host controller shown in FIG. 1.

The host controller 100 shown in FIG. 1 is configured by the computer system having the configuration shown in FIG. 4.

The host controller 100 configured by the computer system as shown in FIG. 4 is provided with a CPU 111, a RAM 112, a communication interface 113, a hard disk controller 114, an FD drive 115, a CDROM drive 116, a mouse controller 117, a keyboard controller 118, a display controller 119, and a communication board 120. These components are connected via a bus 110.

The hard disk controller 114 controls the access to a hard disk 104 built in the host controller 100. The FD drive 115 and the CDROM drive 116 each control access to flexible disk (FD) 130 and CDROM 140 loaded removably on the host controller 100. The mouse controller 117 and the keyboard controller 118 detect the operations of a mouse 107 and a keyboard 108 provided for the host controller 100, and transmit the information to the CPU 111. Based on an instruction of the CPU 111, the display controller 119 displays an image on the display screen of an image display 109 provided for the host controller 100.

The communication board 120 performs communications in accordance with the general-purpose interface protocol such as the SCSI, etc., and transfers compressed image data to the data decompression apparatus 200 (FIG. 1) through the LAN cable 150.

Furthermore, the communication interface 113 performs general-purpose communications such as the Internet, and the host controller 100 can fetch image data through the communication interface 113.

A program stored in the hard disk 104 is read to the RAM 112, and expanded for execution by the CPU 111. The program expanded on the RAM 112 is read and executed by the CPU 111.

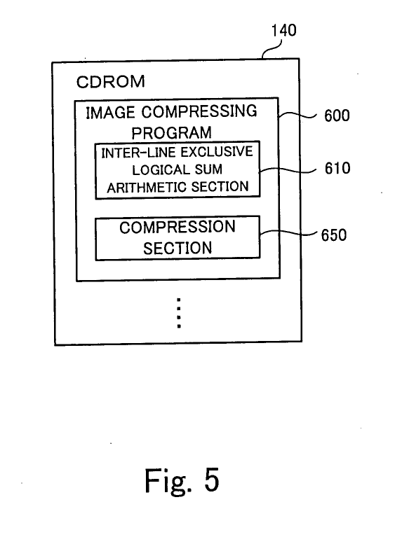

FIG. 5 is a schematic chart of the image compressing program storage medium that is an embodiment of the data compressing program storage medium according to the present invention.

In this example, the CDROM 140 storing an image compressing program 600 is an embodiment of the data compressing program storage medium according to the present invention.

The image compressing program 600 is configured by an inter-line exclusive logical sum arithmetic section 610 and a compression section 650. The CDROM 140 stores various programs for performing a series of processes in the host controller 100 shown in FIG. 1 as well as the image compressing program 600 shown here. However, since they are similar to those in the conventional techniques, the drawings and the descriptions are omitted here.

The CDROM 140 shown in FIG. 5 is loaded into the host controller 100 shown in FIG. 4 and accessed by the CDROM drive 116, and the program stored in the CDROM 140 is uploaded into the host controller 100 and stored in the hard disk 104. When the program stored on the hard disk 104 is read from the hard disk 104, expanded on the RAM 112, and executed by the CPU 111, the host controller 100 functions as a device as a host controller which performs various processes including the process of the image compression apparatus 500 shown in FIG. 3.

The image compressing program 600 shown in FIG. 5 is installed on the host controller 100 and executed by the CPU 111, thereby realizing the image compression apparatus 500 shown in FIG. 3 in the host controller 100. The inter-line exclusive logical sum arithmetic section 610 and the compression section 650 are program parts for operating the inter-line exclusive logical sum arithmetic section 510 and the compression section 550 configuring the image compression apparatus 500 shown in FIG. 3 by the execution by the CPU 111. That is, these program parts can practically structure the components of the image compression apparatus 500 on the host controller 100.

The operations of the inter-line exclusive logical sum arithmetic section 610 and the compression section 650 configuring the image compressing program 600 shown in FIG. 5 when it is executed by the CPU 111 are the operations of the inter-line exclusive logical sum arithmetic section 510 and the compression section 550 configuring the image compression apparatus 500 shown in FIG. 3. Therefore, the descriptions of the inter-line exclusive logical sum arithmetic section 510 and the compression section 550 of the image compression apparatus 500 shown in FIG. 3 and the detailed descriptions below are also applied to the inter-line exclusive logical sum arithmetic section 610 and the compression section 650 configuring the image compressing program 600 shown in FIG. 5.

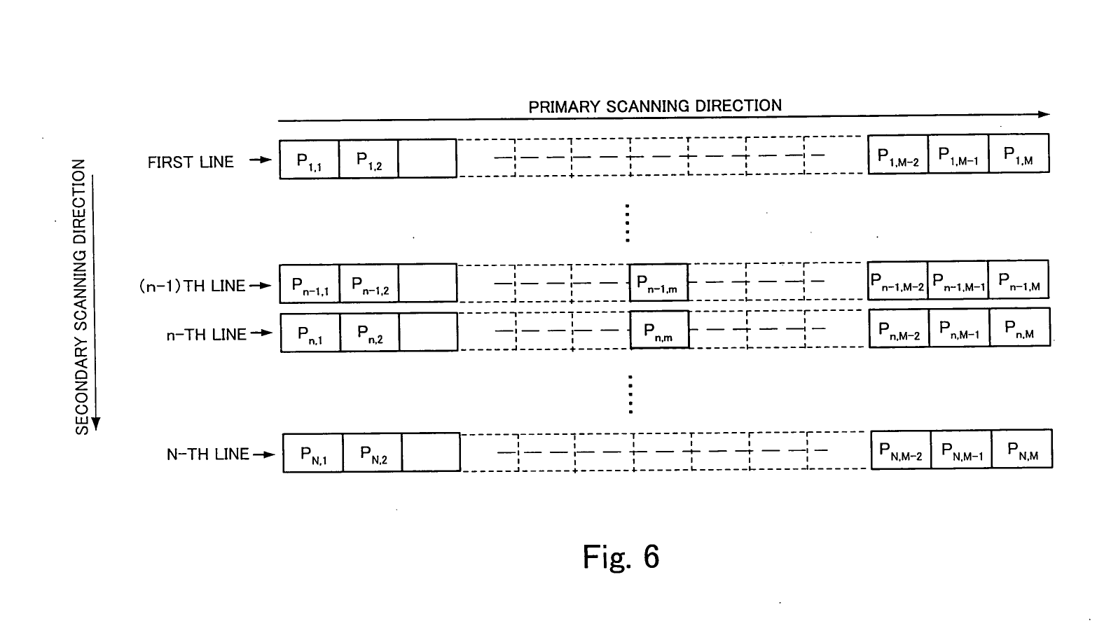

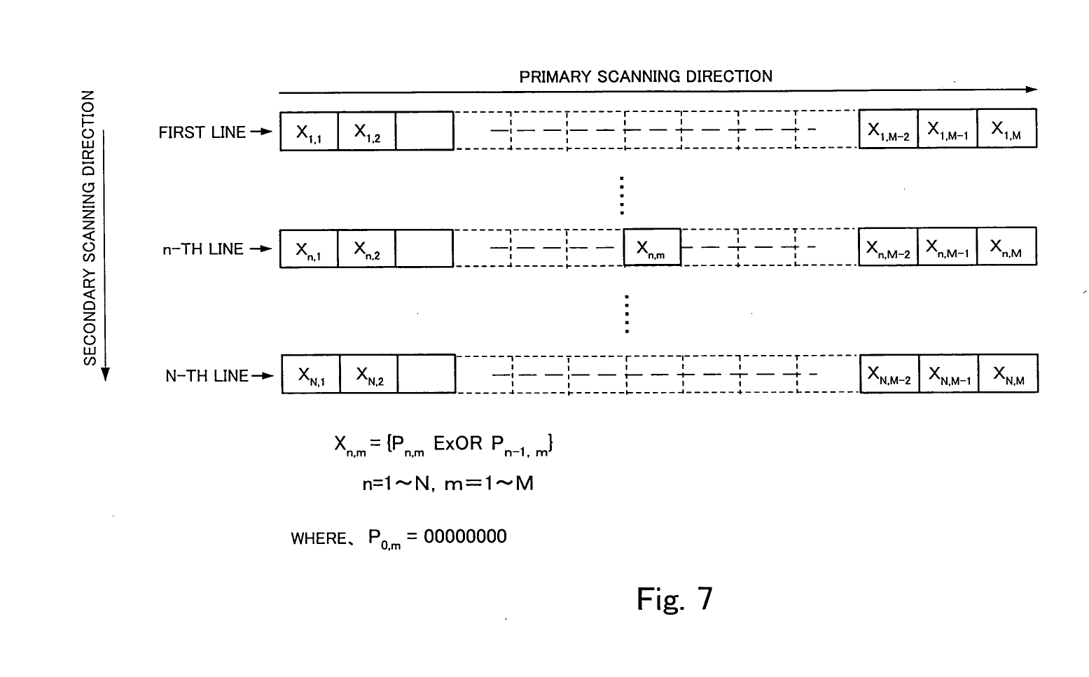

FIG. 6 shows the structure of the binary image data in the binary image file input to the image compression apparatus 500 shown in FIG. 3. FIG. 7 shows the structure of the data after the arithmetic operation for an exclusive logical sum is performed on the data.

The image expressed by the binary image data in the binary image file is formed by pixels arranged in a predetermined primary scanning direction and a secondary scanning direction orthogonal to the primary scanning direction. With such configuration, the binary image data has the structure of a sequence of values of “1” or “0” indicating pixel values in the primary scanning direction and the secondary scanning direction. In FIG. 6, eight values of “1” or “0” arranged in the primary scanning direction are collectively expressed by an 8-bit value of “P”. The binary image data has the structure of N lines in the secondary scanning direction (vertical direction shown in FIG. 6) each including M 8-bit values in the primary scanning direction (horizontal direction in FIG. 6). In FIG. 6, the 8-bit value of the m-th pixel in the n-th line is expressed by P_{n, m}. In this expression, in the n-th line in the secondary scanning direction, the 8-bit value in the primary scanning direction is expressed by P_{n, 1}, P_{n, 2}, . . . , P_{n, m-1}, P_{n, m}, . . . , P_{n, M-2}, P_{n, M-1}, P_{n, M}.

The binary image data is input to the inter-line exclusive logical sum arithmetic section 510 of the image compression apparatus 500 shown in FIG. 3, and an arithmetic operation for an exclusive logical sum is performed on adjacent lines. In the arithmetic process, the above-mentioned 8-bit value is a unit of the process, and the arithmetic operation for an exclusive logical sum is sequentially performed on each value of the 8-bit value in a line between 8-bit values at the same positions in the primary scanning direction of the adjacent lines. Described below is a practical example of the arithmetic operation for an exclusive logical sum. Assume that the 8-bit value at the leftmost position in the top line is

P_{1,1}=00001101

and the 8-bit value at the leftmost position in the second line is

P_{2,1}=00010100.

Consider that the arithmetic operation for an exclusive logical sum is performed between the two 8-bit values. In the arithmetic operation for an exclusive logical sum, the values at the same positions in the sequences of eight values of “1” and “0” each forming an 8-bit value are compared with each other. If they are the same values, “0” is output. If they are different values, “1” is output. A new 8-bit value formed as eight values of the output “1” or “0” is generated. For example, the rightmost value of the P_{1, 1} is “1”, and the rightmost value of the P_{2, 1} is 0. Therefore, the rightmost value of the new 8-bit value is set to “1”. The second value from the rightmost value of P_{1, 1} is “0”, and the second value from the rightmost value of P_{2, 1} is also “0”. Therefore, the second value from the rightmost value of the new 8-bit value is set to “0”. The process is performed on each of the eight values of the two 8-bit values. If the arithmetic operation for an exclusive logical sum of P_{1, 1} and P_{2, 1} is expressed by {P_{1, 1} ExOR P_{2, 1}}, the arithmetic operation for an exclusive logical sum of P_{1, 1} and P_{2, 1}, the following result is obtained as a result of the arithmetic operation for an exclusive logical sum of P_{1, 1} and P_{2, 1}.

{P_{1,1}ExOR P_{2,1}}=00011001

FIG. 7 shows the structure of the data processed by the arithmetic operation for an exclusive logical sum. Each line of the data is formed by M 8-bit values obtained as a result of performing the arithmetic operation for an exclusive logical sum arranged in the primary scanning direction. N lines each configured as described above are arranged in the secondary scanning direction. In the n-th line, the 8-bit value m-th from the leftmost value after the arithmetic operation for an exclusive logical sum is expressed by X_{n, m}. X_{n, m} can be obtained by the following conversion expression from the two 8-bit values, that is, P_{n-1, m} and P_{n, m} before the arithmetic operation for an exclusive logical sum shown at an approximate center part in FIG. 6.

X_{n,m}={P_{n,m}ExORP_{n-1,m}} (1)

where a subscript of 0 is added to the P_{n-1, m} of the right side when n=1. The 8-bit value having a subscript of 0 is defined as follows.

P_{o,m}=00000000 (m=1 to M) (2)

where “00000000” indicates that the value is zero when an 8-bit value is expressed in binary. The equation defines an 8-bit value in a newly added 0-th virtual line in the secondary scanning direction. In the definition of the arithmetic operation for an exclusive logical sum, “1” is output when the 1-bit value forming one 8-bit value (that is, “1” or “0”) is different from the 1-bit value in the same position as the other 8-bit value. Therefore, in the arithmetic operation for an exclusive logical sum of the “00000000” in the equation above and an optional 8-bit value, the optional 8-bit value is output as it is. Therefore, in the data after the arithmetic operation for an exclusive logical sum, the 8-bit value in the first line has a term in which the subscript of “0” is added to the right side of the conversion equation (1). Therefore, the definition of the equation (2) is applied, and the data before the arithmetic operation for an exclusive logical sum is output as it is. As a result, the 8-bit value in the first line is expressed as follows.

X_{1,1}=P_{1,1}

X_{1,2}=P_{1,2}

. . .

X_{1,M}=P_{1,M} (3)

The conversion equation (1) is applied as it is to the 8-bit values in the second and subsequent lines. For example, the 8-bit value in the second line is expressed as follows.

X_{2,1}={P_{2,1}ExORP_{1,1}},

X_{2,2}={P_{2,2}ExORP_{1,2}}

. . .

X_{2,M}={P_{2,M}ExORP_{1,M}} (4)

The data decompression apparatus 200 shown in FIG. 1 performs a data decoding process on the data on which the arithmetic operation for an exclusive logical sum is performed. In the decoding process, first by the equation (3), the 8-bit value in the first line of the data after the arithmetic operation for an exclusive logical sum is output as a decoded 8-bit value. Next, the 8-bit value in the second line is obtained as follows by solving the equation (4) for each of P_{2, 1}, P_{2, 2}, P_{2, 3}, . . . , P_{2, M}.

P_{2,1}={X_{2,1}ExORP_{1,1}},

P_{2,2}={X_{2,2}ExORP_{1,2}}

. . .

P_{2,M}={X_{2,M}ExORP_{1,M}} (5)

In the equation (5), since P_{1, 1}, P_{1, 2}, P_{1, 3}, . . . , P_{1, M} in the right side are respectively equal to X_{1, 1}, X_{1, 2}, X_{1, 3}, . . . , X_{1, M} as an 8-bit value in the first line after the arithmetic operation for an exclusive logical sum, the decoding process is performed also on the second line of the data before the arithmetic operation for an exclusive logical sum by using the equation (5). Similarly, the decoding process is performed also on the 8-bit values in the third and subsequent lines using an equation below obtained by solving the equation (1) for the P_{n, m}.

P_{n,m}={X_{n,m}ExORP_{n-1,m}} and the previously decoded 8-bit value.

Described below is the compressing process performed on the data on which the arithmetic operation for an exclusive logical sum has been performed. The binary image data indicates a monochrome image. Generally, the ratio of the boundary area of the white portion and the black portion to the entire image is very low. Therefore, a number of “0s” in binary representation occur in the data on which the arithmetic operation for an exclusive logical sum has been performed. Therefore, when the data is compressed, the run length coding process of performing a compressing process by coding a sequence of the same values is effective, and the data on which the arithmetic operation for an exclusive logical sum has been performed is input to the run length coding section 551 as one of the components of the compression section 550 shown in FIG. 3. When the data on which the arithmetic operation for an exclusive logical sum has been performed is compressed, the run length coding section 551 processes the 8-bit value forming the data as a unit of the compressing process, and the following coding process is applied to a sequence of 8-bit values from the value “00” to the value “FF” when 8-bit values are expressed in hexadecimal representation.

In this coding process, the process is performed only on a specific value in plural 8-bit values. Therefore, the run length coding section 551 detects a value on which the coding process is to be performed (in this example, the value is referred to as a “compression object value”) and the number of a sequence of the compression object values from the received data. In the present embodiment, “FF” and “00” are examples of the compression object values.

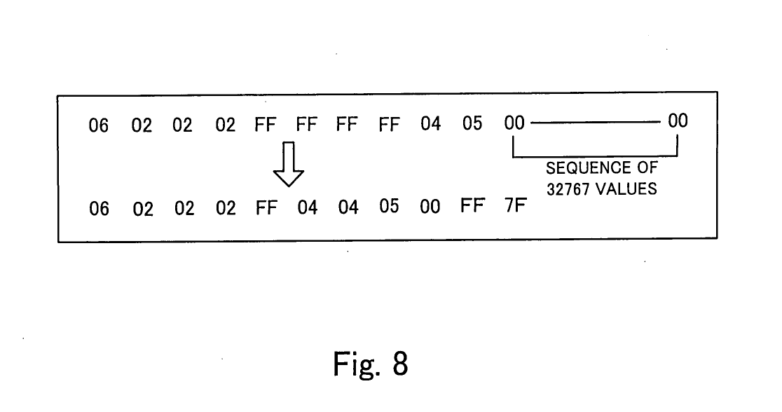

FIG. 8 is an explanatory view of coding by the run length coding section 551 shown in FIG. 3.

The upper line in FIG. 8 shows the data before the coding process by the run length coding section 551, and the lower line shows the data after performing the coding process on the upper line data by the run length coding section 551.

In this example, as indicated by the lines shown in FIG. 8, it is assumed that the data “06 02 02 02 FF FF FF FF 04 05 00 . . . ” is input from the run length coding section 551. At this time, the run length coding section 551 shown in FIG. 3 detects that the leading “06” is not a compression object value, the next “02 02 02” is not a compression object value, the four compression object values “FF” continue, “04” and “05” which are not compression object values are input, and then 32767 compression object values “00” continue.

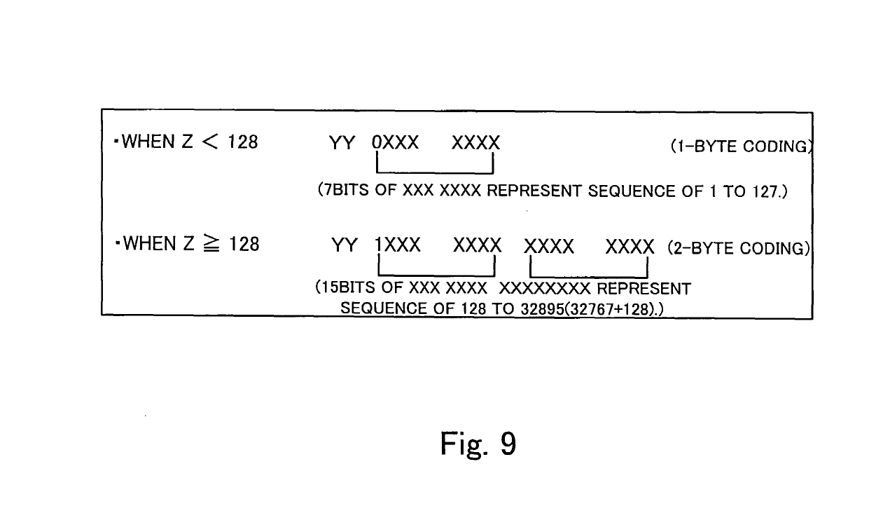

FIG. 9 shows an algorithm of coding on a compression object value by the run length coding section.

In FIG. 9, Z indicates the number of repetitions of the same compression object values. For example, Z=4 for “FF” in the upper line shown in FIG. 8, and Z=32767 for “00”.

In FIG. 9, “YY” indicates the compression object value itself expressed by two digits in hexadecimal. “0” or “1” following the “YY” indicates “0” or “1” expressed by 1 bit. In the subsequent “XXX XXXX . . . ”, one “X” indicates one bit, and “XXX XXXX . . . ” represents the value of Z.

That is, in FIG. 9, when the compression object value “YY” continues Z times (Z<128), the eighth bit represents the compression object value “YY”, the subsequent eight bits containing the leading bit of “0” and the subsequent 7 bits represent the value of Z. When the compression object value “YY” continues Z times (Z≧128), the eighth bit represents the compression object value “YY” and the first byte of the subsequent two bytes (16 bits) is set as “1” to indicate the representation by the continuous two bytes. The 15 subsequent bits represent the value of Z.

Based on the rule shown in FIG. 9, an example of coding shown in FIG. 8 is described below.

Since the leading value “06” forming the data of (upper line) before the run length coding process indicated in the line shown in FIG. 8 is not a compression object value, the value “06” is output as it is. The following “02 02 02” is output as it is because “02” is not a compression object value. Next, since there are four continuous compression object values “FF,” they are coded into “FF 04.” The subsequent “04” and “05” are not compression object values. Therefore, “04 05” is output as it is.

Next, since “00” continues 32767 times, “00” is input, the leading 1 bit of the next 16 bits is set to “1”, and 15 bits represent 32767−128=32639. As a result, three bytes of “00 FF 7F” represent 32767 continuous “00”.

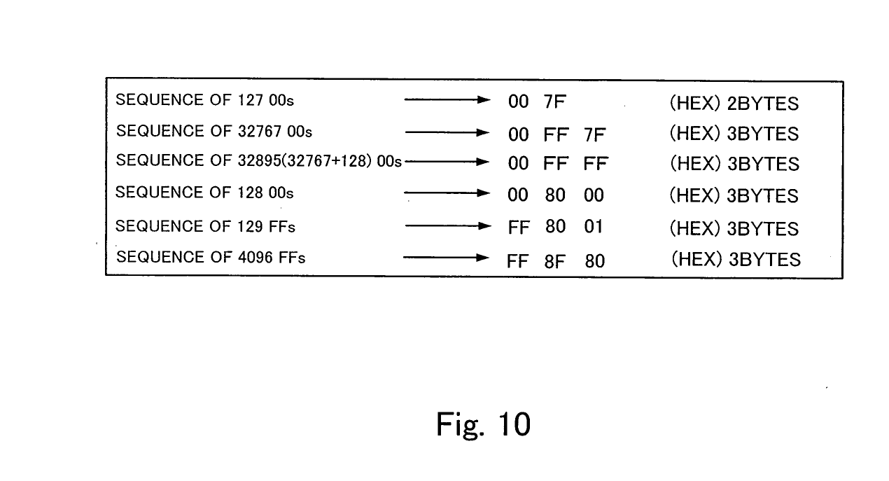

FIG. 10 shows an example of the coding process on the basis of the number of repetitions by the run length coding section 551 shown in FIG. 3.

When “00” continues 127 times, it is coded as “00 7F” using two bytes.

When “00” continues 32767 times, it is coded as “00 FF 7F” using three bytes.

When “00” continues 32895 times, it is coded as “00 FF FF” using three bytes.

When “00” continues 128 times, it is coded as “00 80 00” using three bytes.

When “FF” continues 129 times, it is coded as “FF 80 01” using three bytes.

When “FF” continues 4096 times, it is coded as “FF 8F 80” using three bytes.

The run length coding section 551 shown in FIG. 3 performs the above-mentioned coding process.

Considerable data compressing can be expected from the coding process by the run length coding section 551.

The data after performing the above-mentioned coding process by the run length coding section 551 shown in FIG. 3 is input to the data scanning section 552 and the Huffman coding section 553 forming the compression section 550 shown in FIG. 3.

The data scanning section 552 first scans the entire data output from the run length coding section 551, and obtains the frequency of occurrence of the data value.

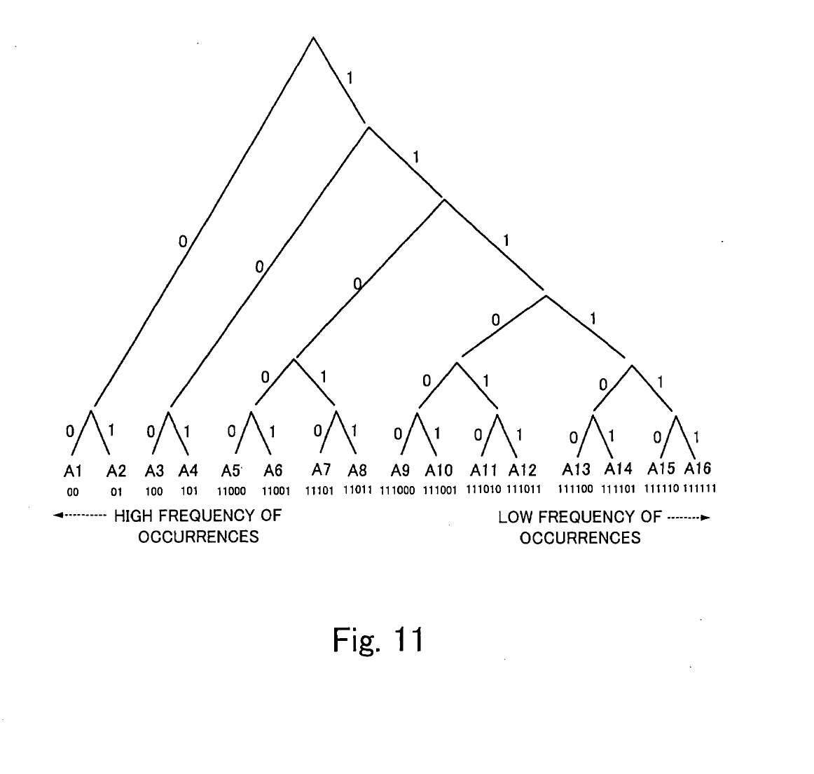

FIG. 11 shows an example of the result of the scanning by the data scanning section 552.

In this example, assume that the frequency of occurrence of “A1” is the highest, and followed by “A2”, “A3”, “A4”, . . . in this order. “A1”, “A2”, etc. do not directly represent values, but represent codes indicating values. That is, “A1” refers to the value “00”, “A2” refers to the value “FF”, and so on. In this description, for simplicity, the data transmitted from the run length coding section 551 shown in FIG. 3 is one of the 16 values “A1” to “A16”. For each of the 16 values, the data scanning section 552 generates a Huffman table with a code assigned on the basis of the frequency of occurrence. That is, the code “00” expressed by two bits is assigned to “A1” having the highest frequency of occurrence. Next, the code “01” expressed by two bits is assigned to “A2.” The codes “100” and “101” expressed by three bits are respectively assigned to the next “A3” and “A4,” and the code expressed by five bits is each assigned to the subsequent “A5” to “A8.” Similarly, a code expressed by a larger number of bits is assigned to a value having a lower frequency of occurrence.

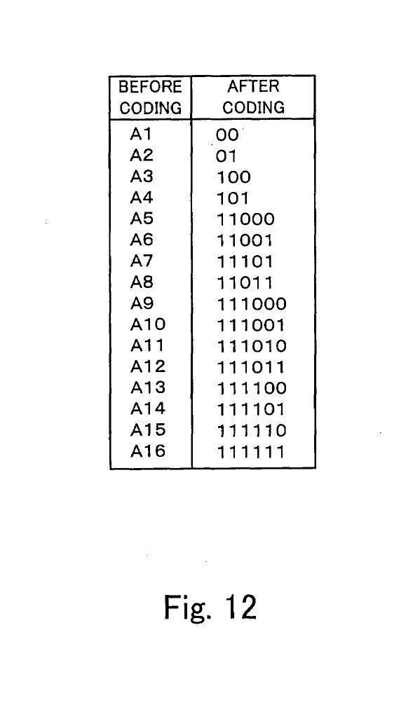

FIG. 12 shows an example of a Huffman table.

The Huffman table corresponds to the one shown in FIG. 11, and is a correspondence table between a value before coding (before replacement) and a value after coding (after replacement) in which a value of a higher frequency of occurrence is replaced with a code represented by a shorter number of bits.

The Huffman coding section 553 forming the compression section 550 shown in FIG. 3 codes a value of data on the basis of Huffman table. As a result, a large number of values are replaced with codes of short number of bits, thereby realizing data compression.

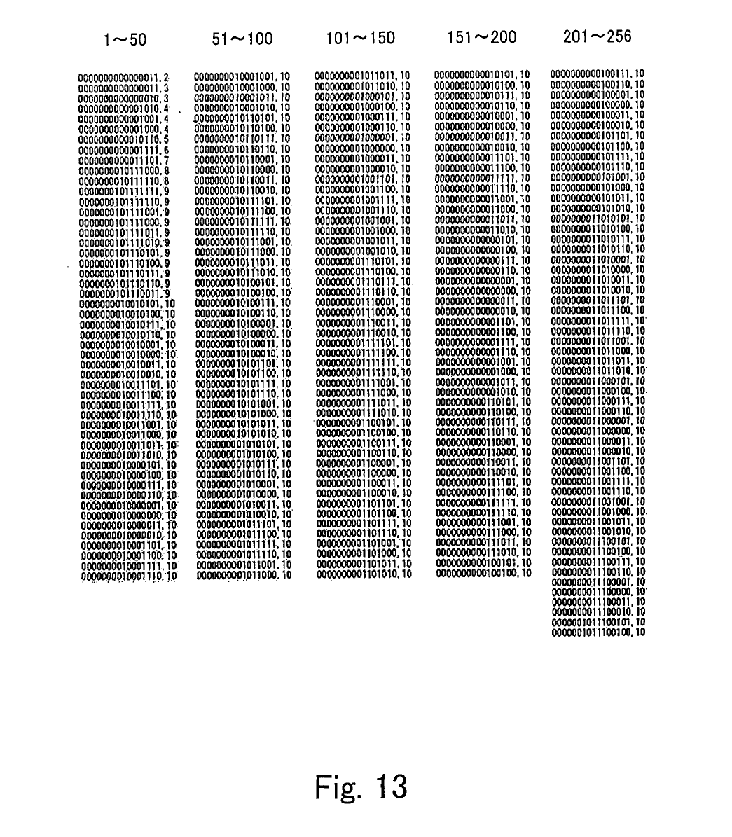

FIG. 13 shows a practical example of a code string prepared on the Huffman table.

In the code string shown in FIG. 13, the values in the right of “,” in each code string indicate the bit length, and the binary code in the left of the “,” of the bit length indicates the actual code. For example, the first code at the upper left shown in FIG. 13 is a 2-bit code of “11”, the second code is a 3-bit code of “011”, the third code is a 3-bit code of “010”, and the fourth code is a 4-bit code of “1010”. With this code string, a value of a higher frequency of occurrence is replaced with a code of a smaller number of bits.

In the above-mentioned processes shown in FIGS. 8 to 13, the data input to the compression section 550 shown in FIG. 3 can be compressed at a high compression rate by performing coding by the run length coding section 551 and the Huffman coding section 553 into the compressed data D2.

In the present embodiment of the present invention, the compression section 550 shown in FIG. 3 performs a compressing process using eight bits as a unit. However, the compression unit by the compression section is not limited to the 8-bit value, and the compressing unit can be, for example, 12 bits, 16 bits.

What is claimed is:

1. A data compression apparatus which performs a data compressing process on data to be compressed, the data being formed by a sequence of values each expressed by a 1-bit value, the apparatus comprising:
a data conversion section which generates new data to be compressed, the new data being formed by a sequence of values each expressed by a 1-bit value, the 1-bit value indicating whether or not an adjacent value is an equal value in the sequence of values; and
a data compression section which performs a compressing process on the new data generated by the data conversion section.

2. The data compression apparatus according to claim 1, wherein the data compression section performs a reversible compressing process on the data generated by the data conversion section.

3. The data compression apparatus according to claim 1, wherein the data compression section comprises a first coding section which outputs values in the new data excluding one or more predetermined compression object values as they are and outputs a coded value representing the compression object value and a coded value representing a number of repetitions of the compression object value.

4. The data compression apparatus according to claim 1, wherein the data compression section comprises:
a first coding section which outputs values in the new data excluding one or more predetermined compression object values as they are and outputs a coded value representing the compression object value and a coded value representing a number of repetitions of the compression object value; and
a second coding section which performs an entropy coding process on data coded by the first coding section using a table for correspondence between a code and a value.

5. The data compression apparatus according to claim 1, wherein the data compression section comprises:
a first coding section which outputs values in the new data excluding one or more predetermined compression object values as they are and outputs a coded value representing the compression object value and a coded value representing a number of repetitions of the compression object value; and
a second coding section which performs a Huffman coding process on data coded by the first coding section using a Huffman table.

6. The data compression apparatus according to claim 1, wherein the data compression section comprises:
a first coding section which outputs values in the new data excluding one or more predetermined compression object values as they are and outputs a coded value representing the compression object value and a coded value representing a number of repetitions of the compression object value;
a histogram calculation section which obtains a histogram of a value occurring in data coded by the first coding section;
a code assignment section which assigns a code having a shorter length for a value of a higher frequency of occurrences to a table for correspondence between a code and a value on a basis of the histogram obtained by the histogram calculation section; and
a second coding section which performs an entropy coding process on data coded by the first coding section using a table with a code assigned by the code assignment section.

7. The data compression apparatus according to claim 1, wherein the data compression section performs a compressing process on the data generated by the data conversion section using, as a unit of the compressing process, an 8-bit value formed by a sequence of eight continuous values each expressed by a 1-bit value.

8. The data compression apparatus according to claim 7, wherein the data compression section performs a reversible compressing process on the data generated by the data conversion section.

9. The data compression apparatus according to claim 7, wherein the data compression section comprises a first coding section which outputs values in the new data excluding one or more predetermined compression object values as they are and outputs a coded value representing the compression object value and a coded value representing a number of repetitions of the compression object value.

10. The data compression apparatus according to claim 7, wherein the data compression section comprises:
a first coding section which outputs values in the new data excluding one or more predetermined compression object values as they are and outputs a coded value representing the compression object value and a coded value representing a number of repetitions of the compression object value; and
a second coding section which performs an entropy coding process on data coded by the first coding section using a table for correspondence between a code and a value.

11. The data compression apparatus according to claim 7, wherein the data compression section comprises:
a first coding section which outputs values in the new data excluding one or more predetermined compression object values as they are and outputs a coded value representing the compression object value and a coded value representing a number of repetitions of the compression object value; and
a second coding section which performs a Huffman coding process on data coded by the first coding section using a Huffman table.

12. The data compression apparatus according to claim 7, wherein the data compression section comprises:
a first coding section which outputs values in the new data excluding one or more predetermined compression object values as they are and outputs a coded value representing the compression object value and a coded value representing a number of repetitions of the compression object value;
a histogram calculation section which obtains a histogram of a value occurring in data coded by the first coding section;
a code assignment section which assigns a code having a shorter length for a value of a higher frequency of occurrences to a table for correspondence between a code and a value on a basis of the histogram obtained by the histogram calculation section; and
a second coding section which performs an entropy coding process on data coded by the first coding section using a table with a code assigned by the code assignment section.

13. A computer readable medium storing a data compressing program that is incorporated into and causes an information processing apparatus to perform a data compressing process on data to be compressed, the data being formed by a sequence of values each expressed by a 1-bit value, the data compressing program implementing in the information processing apparatus:
a data conversion section which generates new data to be compressed, the new data being formed by a sequence of values each expressed by a 1-bit value, the 1-bit value indicating whether or not an adjacent value is an equal value in the sequence of values; and
a data compression section which performs a compressing process on the new data generated by the data conversion section.
